(19) United States
(12) Patent Application Publication
(10) Pub. No.: US 2020/0133832 A1
(43) Pub. Date: Apr. 30, 2020

(54) Data processing method for memory and related data processor

(71) Applicant: Yangtze Memory Technologies Co., Ltd., Wuhan City (CN)

(72) Inventors: Qikang Xu, Wuhan City (CN); Xiang Fu, Wuhan City (CN); Zongliang Huo, Wuhan City (CN)

(21) Appl. No.: 16/198,744

(22) Filed: Nov. 21, 2018

Related U.S. Application Data
(63) Continuation of application No. PCT/CN2018/112149, filed on Oct. 26, 2018.

(51) Int. Cl. G06F 12/02

(52) U.S. Cl. CPC G06F 12/0223; G06F 2212/2022; G06F 2212/1044

(57) ABSTRACT

The present invention provides a data processing method for a memory and a related data processor for performing the method. A page of data may be divided into multiple groups. In each group, the number of “1”s and the number of “0”s are determined, so as to determine whether to reverse or keep the bit data in the group. The encoding scheme may make the bit value “0” more concentrated on the middle states of the state distribution than the bit value “1”. The data processor thereby reverses the bit data in a group if the number of “1”s is greater than the number of “0”s in the group, and keeps the bit data in a group if the number of “1”s is less than the number of “0”s in the group. As a result, the occurrence probability of the states at two sides becomes lower and the occurrence probability of the middle states becomes higher. This improves data retention of the memory.

### CROSS REFERENCE TO RELATED APPLICATIONS

The present application is a continuation application of International Application No. PCT/CN2018/112149, filed on Oct. 26^{th}, 2018. The present application is based on and claims priority to International Application No. PCT/CN2018/112149, filed on Oct. 26^{th}, 2018, the contents of which are incorporated herein by reference in its entirety.

### BACKGROUND OF THE INVENTION

### 1. Field of the Invention

The present invention relates to a data processing method for a memory, and more particularly, to a data processing method for a quad-level cell (QLC) NAND flash memory.

### 2. Description of the Prior Art

A non-volatile memory is a type of computer memory that may store data and the data may not be lost after electric power of the computer system is cut off. Among those non-volatile memory systems, the NAND flash memory, which has advantages of low power and high speed, becomes popular with the widespread use of portable devices in recent years.

The NAND flash memory stores data in individual memory cells. Traditionally, each memory cell has two possible states, so one bit of data is stored in each cell, which makes up a so-called single-level cell (SLC) flash memory. The SLC memory has the advantages of higher write speed, lower power consumption and higher cell endurance capability. Since the SLC flash memory stores only one bit data per cell, it costs more to manufacture a unit of storage space. In order to reduce the cost, NAND flash vendors constantly dedicate their efforts to increase storage density, and the multi-bit-cell (MBC) flash memory such as a multi-level cell (MLC) flash memory is therefore generated. The “MBC” refers to a memory element capable of storing more than one single bit of data. The MBC flash is a flash memory technology using multiple levels per cell to allow more bits to be stored using the same number of transistors.

In the SLC flash technology, each cell can exist in one of two states, storing one bit of data per cell. In comparison, the MLC flash memory has four possible states per cell, so it can store two bits of data per cell. Due to the higher data density of the MLC flash memory, it can enjoy the benefit of lower cost per bit of stored data. However, the MLC flash technology reduces the amount of margin separating the states, which results in the increased possibility of errors. Nowadays, the triple-level cell (TLC) and quad-level cell (QLC) flash memories are developed, where each cell is configured to store 3 and 4 bits of data, respectively. For example, in a QLC NAND flash memory, one cell may store 4 bits of data; hence, the cell may be in one of 16 different states, as denoted by E (also called D0), D1, D2, . . . and D15.

In a charge trapping type NAND flash memory, all memory cells in one channel hole share the same charge trapping layer (CTL) . Please refer to FIG. 1, which is a schematic diagram of a section view of a charge trapping type NAND flash memory, where the blocking oxide, CTL, tunnel oxide, and poly-silicon channel are illustrated. In the CTL, electrons may be inserted by programming memory cells based on the data through voltage received from the cell gate terminals, to determine the states of the memory cells. When two adjacent cells in one channel hole store different states, the electrons and holes in the CTL drift to adjacent cells, especially when there are state combination (E, D15) or (D15, E) stored in two adjacent cells in the same channel hole, as shown in FIG. 2. In detail, the electrons in the D15-state cell may laterally spread to the E-state cell, and the holes in the E-state cell may laterally spread to the D15-state cell. The accuracy of the stored data maybe reduced and the data retention problem may become severe in such a state arrangement.

In the prior art, the NAND flash system does not deal with this problem. The NAND flash system merely randomizes input data and then stores the randomized data, where the randomization procedure cannot change the occurrence probability of (E, D15) or (D15, E) state arrangement, and thus cannot improve the data retention problem. Thus, there is a need for improvement over the prior art.

### SUMMARY OF THE INVENTION

It is therefore an objective of the present invention to provide a data processing method which is capable of reducing the occurrence probability of state combination (E, D15) or (D15, E) in two adjacent cells in one channel hole, in order to mitigate the data retention problem.

An embodiment of the present invention discloses a data processing method. The data processing method comprises dividing a page of bit data into a plurality of groups; counting the number of a first bit value and the number of a second bit value in each of the plurality of groups; comparing the number of the first bit value and the number of the second bit value; performing a reshaping procedure on each of the plurality of groups based on the result of comparing the number of the first bit value and the number of the second bit value; and storing the page of bit data in memory after the reshaping procedure.

Another embodiment of the present invention discloses a data processor for processing bit data. The data processor comprises a receiver and a processing unit. The receiver is configured for receiving a page of bit data. The processing unit is configured for performing the following units: dividing unit, for dividing the page of bit data into a plurality of groups; counting unit, for counting the number of a first bit value and the number of a second bit value in each of the plurality of groups; comparing unit, for comparing the number of the first bit value and the number of the second bit value; performing unit, for performing a reshaping procedure on each of the plurality of groups based on the result of the comparing unit; and storing unit, for storing the page of bit data into memory after the reshaping procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a section view of a charge trapping type NAND flash memory.

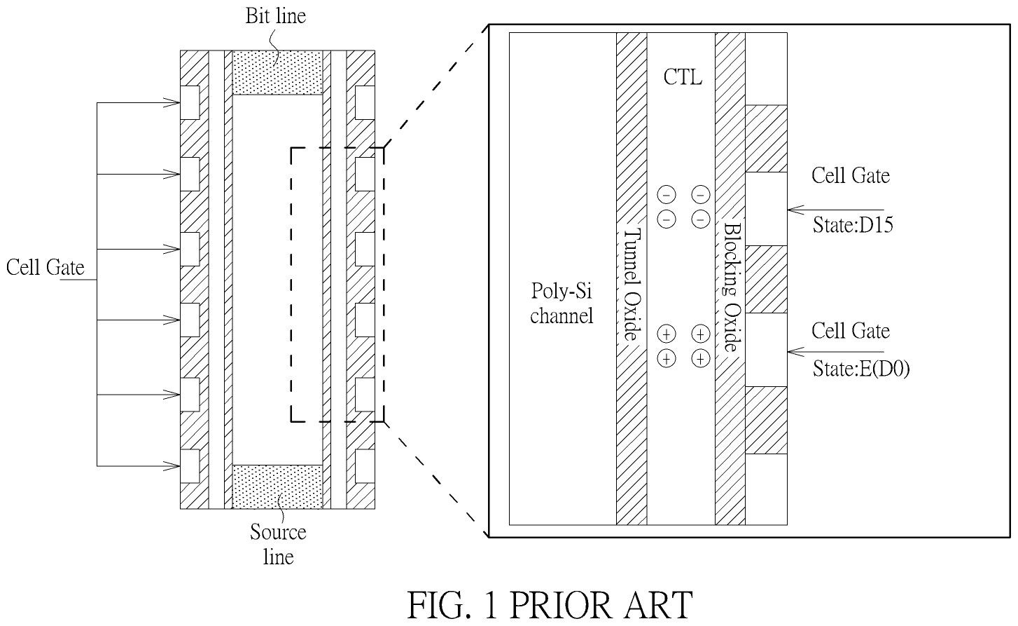

FIG. 2 is a schematic diagram of state combination having the worst performance in a QLC type NAND flash.

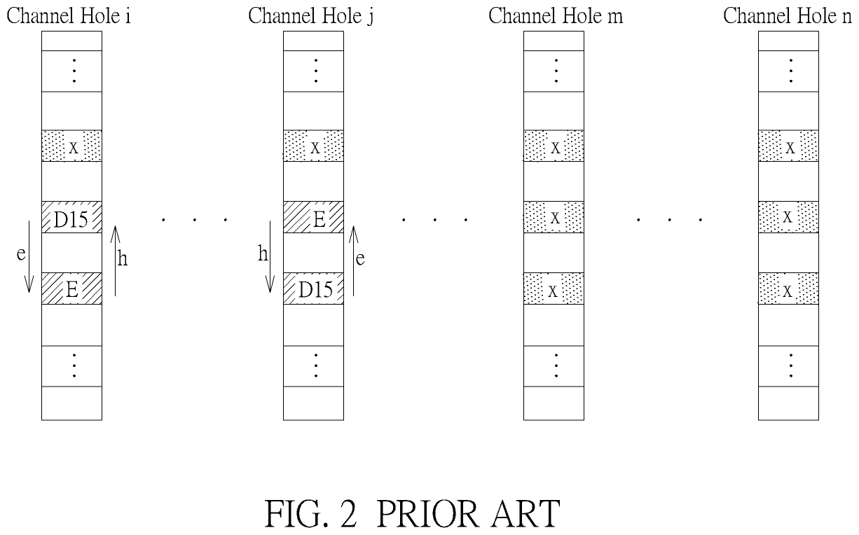

FIG. 3 is a schematic diagram of a data processing system according to an embodiment of the present invention.

FIG. 4A is a schematic diagram of the ratio of each state in memory cells belonging to one word line of a QLC type NAND flash memory in a general case.

FIG. 4B is a schematic diagram of the ratio of each state in memory cells belonging to one word line of a QLC type NAND flash memory after processing of the data processor.

FIG. 5 is a schematic diagram of a data processing process according to an embodiment of the present invention.

FIG. 6 is a schematic diagram of an implementation of dividing a page of data into multiple groups and the data storing arrangement in a page of the NAND flash memory.

### DETAILED DESCRIPTION

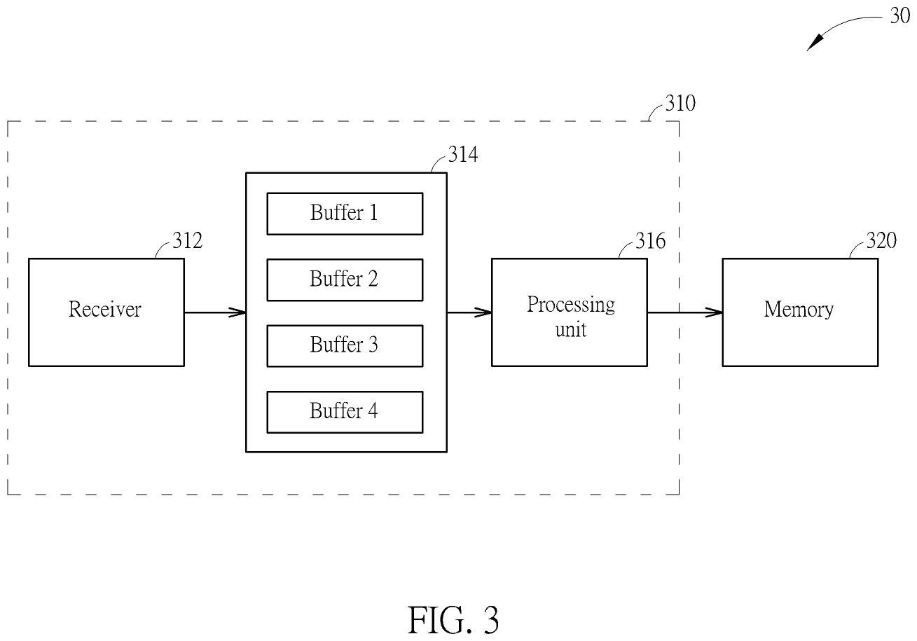

Please refer to FIG. 3, which is a schematic diagram of a data processing system 30 according to an embodiment of the present invention. As shown in FIG. 3, the data processing system 30 includes a data processor 310 and a memory 320. The data processor 310 is configured to receive user data and output the data to the memory 320, to store the data in the memory 320. In an embodiment, the memory 320 may be an NAND flash memory, and the data processor 310 may be a flash controller or any other related processing device. The data processor 310 includes a receiver 312, several buffers 314 and a processing unit 316. The data to be stored is received by the receiver 312 and then stored in the buffers 314. Each buffer may store a page of data or a group of data divided from a page, depending on configurations of the processing unit 316. The processing unit 316 may be a control logic or processing logic included in an integrated circuit, for processing the data before the data is transmitted to the memory 320.

As mentioned above, when two adjacent memory cells in one channel hole store different states, the electrons and holes in the charge trapping layer (CTL) may drift to adjacent cells, especially when there are state combination (E, D15) or (D15, E) stored in two adjacent cells. This results in data retention problem. The present invention solves this problem through a data processing technique which reduces the occurrence probability of the states “E” and “D15”, which in turn reduces the probability that the state combination (E, D15) or (D15, E) appears to be stored in two adjacent cells.

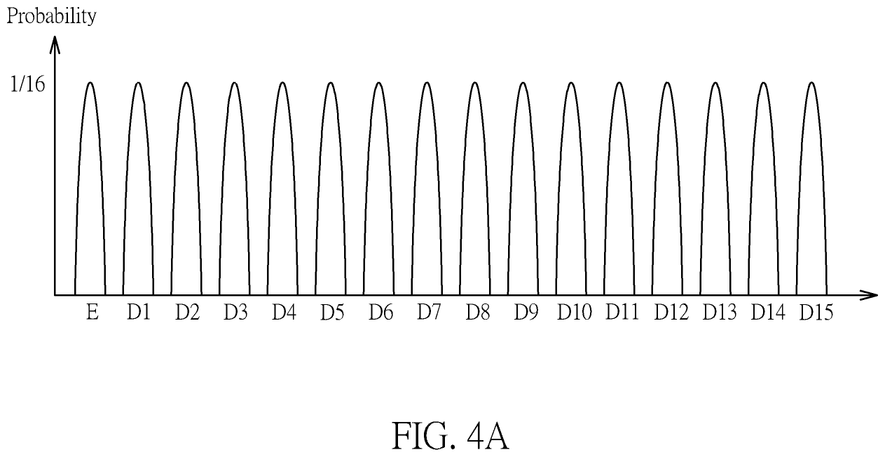

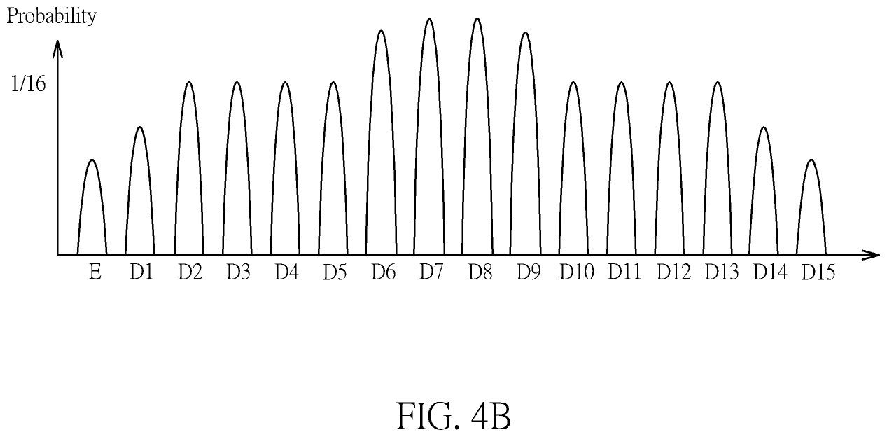

Please refer to FIGS. 4A and 4B, which are schematic diagrams of state distributions of memory cells belonging to one word line. FIG. 4A illustrates a state distribution in memory cells belonging to one word line of a QLC type NAND flash memory before processing of the data processor 310, and FIG. 4B illustrates a state distribution in memory cells belonging to one word line of a QLC type NAND flash memory after processing of the data processor 310. In general, the received data may pass through a randomizer, which allows the occurrence probability of data bits “1” and “0” to be substantially equal. In such a situation, in the cells of the memory 320, the occurrence probability of each state from “E” to “D15” maybe similar or equal to each other, as shown in FIG. 4A. Thus, the occurrence probability of the state “E” or “D15” is substantially equal to 1/16.

The data processor 310 of the present invention will process the input data and reshape the state distribution to be similar to that shown in FIG. 4B. In such a situation, the occurrence probability of the states at two sides becomes lower and the occurrence probability of the middle states becomes higher. This reduces the occurrence probability of the states “E” and “D15”, and thereby reduces the probability that the state combination (E, D15) or (D15, E) appears in two adjacent cells in one channel hole.

More specifically, the state distribution shown in FIG. 4B may be realized by using a specific bit encoding scheme and changing the probabilities of bit values “1” and “0” in the data to be stored. In an embodiment, the bit encoding scheme may encode bit values corresponding to the state distribution by making the bit value “0” more concentrated on the middle states of the state distribution than the bit value “1”. An exemplary implementation of the encoding scheme is illustrated in Table 1, as shown below:

TABLE 1

| Code | E | D1 | D2 | D3 | D4 | D5 | D6 | D7 | D8 | D9 | D10 | D11 | D12 | D13 | D14 | D15 |
|---|---|---|---|---|---|---|---|---|---|---|---|---|---|---|---|---|
| Page 4 | 1 | 1 | 0 | 0 | 0 | 0 | 0 | 0 | 1 | 1 | 1 | 0 | 0 | 1 | 1 | 1 |
| Page 3 | 1 | 1 | 1 | 1 | 1 | 0 | 0 | 1 | 1 | 0 | 0 | 0 | 0 | 0 | 0 | 1 |
| Page 2 | 1 | 0 | 0 | 1 | 1 | 1 | 0 | 0 | 0 | 0 | 0 | 0 | 1 | 1 | 1 | 1 |
| Page 1 | 1 | 1 | 1 | 1 | 0 | 0 | 0 | 0 | 0 | 0 | 1 | 1 | 1 | 1 | 0 | 0 |

As shown in Table 1, the bit value “0” is more concentrated on the middle states (near “D6”) while the bit value “1” is more concentrated on the two-side states (near “E” and “D15”). In this embodiment, the memory 320 is a QLC NAND flash memory, and thus each memory cell in the memory 320 is configured to store 4 bits of data, and these 4 bits of data belong to 4 pages of bit data, e.g., Page 1 to Page 4 shown in Table 1. For each memory cell, the combination of 4 bit values “1” and/or “0” in the corresponding bit of Page 1-4 is mapped to one of the states from “E” to “D15”. For example, if the bit values stored in a memory cell are “1”, “1”, “1” and “1” corresponding to Page 1, Page 2, Page 3 and Page 4, respectively, the state of this memory cell may be “E”. If the bit values stored in a memory cell are “1”, “0”, “1” and “1” corresponding to Page 1, Page 2, Page 3 and Page 4, respectively, the state of this memory cell may be “D1”.

According to the encoding scheme shown in Table 1, the bit value “0” is more concentrated on the middle states and the bit value “1” is more concentrated on the two-side states. In order to decrease the occurrence probability of the two-side states and increase the occurrence probability of the middle states, the data stored in the memory 320 should include “0”s as more as possible, i.e., include “1”s as less as possible. However, under most circumstances, the bit data received from a user or from other device may not be determined by the data processor 310, such that the numbers of received “1”s and “0”s cannot be predetermined. In order to store “0”s as more as possible, the data processor 310 may divide the received data into small groups, count the “1”s and “0”s in each group, and reverse the bit data in a group if the number of “1”s is greater than the number of “0”s in the group, so as to generate more “0”s in the data to be stored in the memory 320.

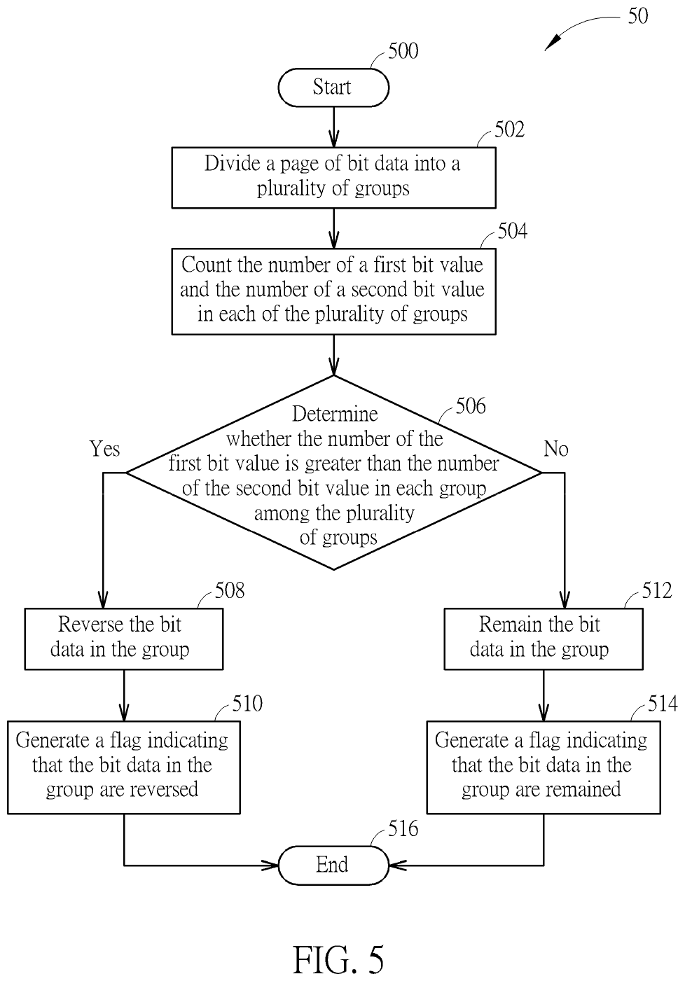

In detail, please refer to FIG. 5, which is a schematic diagram of a data processing process 50 according to an embodiment of the present invention. As shown in FIG. 5, the data processing process 50, which may be implemented in a data processor used for a memory such as the data processor 310 shown in FIG. 3, includes the following steps:

Step 500: Start.

Step 502: Divide a page of bit data into a plurality of groups.

Step 504: Count the number of a first bit value and the number of a second bit value in each of the plurality of groups.

Step 506: Determine whether the number of the first bit value is greater than the number of the second bit value in each group among the plurality of groups. If yes, go to Step 508; otherwise, go to Step 512.

Step 508: Reverse the bit data in the group.

Step 510: Generate a flag indicating that the bit data in the group are reversed.

Step 512: Remain the bit data in the group.

Step 514: Generate a flag indicating that the bit data in the group are remained.

Step 516: End.

According to the data processing process 50 together with the structure of the data processor 310 shown in FIG. 3, the receiver 312 may receive a page of bit data and store the data in the buffer 314. Afterwards, the processing unit 316 divides the page of bit data into multiple groups, and counts the number of the first bit value and the number of the second bit value in each group. The processing unit 316 then determines whether the number of the first bit value is greater than the number of the second bit value, and reverses the bit data or remains the bit data based on the determination result, so as to reshape or modify the occurrence probability of the states in the state distribution in the memory cells; more particularly, to increase the occurrence probability of the middle states and decrease the occurrence probability of the two-side states. In the reshaping procedure, the processing unit 316 reverses the bit data in a group, i.e., interchanges the first bit value and the second bit value in each bit of the group, if the number of the first bit value is greater than the number of the second bit value. On the contrary, if the number of the first bit value is less than the number of the second bit value, the processing unit 316 remains the bit data in the group. In an embodiment, the first bit value is “1” and the second bit value is “0”; hence, the reshaping procedure allows the number of “0”s to be more than or equal to the number of “1”s in each group of data to be stored in the memory 320.

In general, a page of data may include several kilobytes or several tens of kilobytes of bit data, where the data quantity in a page is quite large. With larger data quantity, the ratio of “0”s in a page may be closer to 50% more probably; hence, the method of reversing the bit data in an entire page may not gain a preferable benefit with increase of the number of “0”s. In such a situation, each page of data is divided into multiple groups, and the determinations of the numbers of “1”s and “0”s are performed individually for each group. The size of a group may be 64 bits, 128 bits, or any other feasible value. With the smaller size in each group, there may be a significant difference between the number of “1”s and the number of “0”s in each group.

Please note that for each group, a flag may be generated or assigned to indicate that the bit data in this group are reversed or remained in the reshaping procedure. In an embodiment, the flag may be realized with a bit, where the bit value “1” indicates that the bit data is reversed and “0” indicates that the bit data is remained, or the bit value “0” indicates that the bit data is reversed and “1” indicates that the bit data is remained. The flag may also be stored in the memory 320 together with the corresponding group of data.

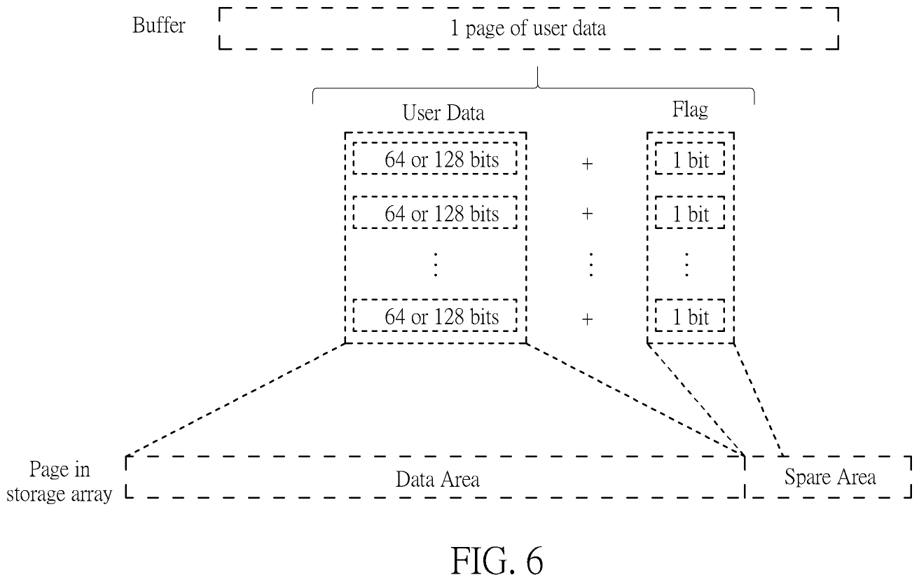

FIG. 6 illustrates an implementation of dividing a page of user data into multiple groups and the data storing arrangement in a page of the NAND flash memory, where the page may have 16 k bytes of data while each group may have 64 or 128 bits of data. Each group has a flag bit indicating that the bit data in the group is reversed or remained. As shown in FIG. 6, both the page of data and the flags are stored in a storage array of a page in the NAND flash memory, where the data may be stored in the data area and the flag may be stored in a part of the spare area of the NAND flash memory. In this embodiment, the flag consumes no more than 2% of the storage capacity.

Please note that the present invention aims at providing a data processing method for mitigating the data retention problem in a flash memory. Those skilled in the art may make modifications and alternations accordingly. For example, the above embodiments are dedicated to the QLC NAND flash memory since the data retention problem may be more severe in the QLC NAND flash memory in modern flash memory technology. However, those skilled in the art should understand that the data processing method and the data processor of the present invention are also applicable to other type of memories such as the triple-level cell (TLC) flash memory. In addition, the encoding method illustrated in Table 1 is only one of various implementations of the present invention. Another encoding scheme is also feasible if it encodes the bit values to make a first bit value more concentrated on the middle states and make a second bit value more concentrated on the two-side states. For example, as shown in Table 2 and Table 3, the bit value “0” is also more concentrated on the middle states than the bit value “1”, and the encoding scheme may be incorporated with the data processing method of the present invention to reduce the probability that the state combination (E, D15) or (D15, E) appears in two adjacent cells in the same channel hole.

TABLE 2

| Code | E | D1 | D2 | D3 | D4 | D5 | D6 | D7 | D8 | D9 | D10 | D11 | D12 | D13 | D14 | D15 |
|---|---|---|---|---|---|---|---|---|---|---|---|---|---|---|---|---|
| Page 4 | 1 | 0 | 0 | 1 | 1 | 1 | 0 | 0 | 0 | 0 | 1 | 1 | 1 | 0 | 0 | 1 |
| Page 3 | 1 | 1 | 0 | 0 | 0 | 1 | 1 | 0 | 0 | 0 | 0 | 0 | 1 | 1 | 1 | 1 |
| Page 2 | 1 | 1 | 1 | 1 | 0 | 0 | 0 | 0 | 0 | 1 | 1 | 0 | 0 | 0 | 1 | 1 |
| Page 1 | 1 | 1 | 1 | 1 | 1 | 1 | 1 | 1 | 0 | 0 | 0 | 0 | 0 | 0 | 0 | 0 |

TABLE 3

| Code | E | D1 | D2 | D3 | D4 | D5 | D6 | D7 | D8 | D9 | D10 | D11 | D12 | D13 | D14 | D15 |
|---|---|---|---|---|---|---|---|---|---|---|---|---|---|---|---|---|
| Page 4 | 1 | 0 | 0 | 1 | 1 | 1 | 0 | 0 | 0 | 1 | 1 | 0 | 0 | 0 | 1 | 1 |
| Page 3 | 1 | 1 | 0 | 0 | 0 | 1 | 1 | 0 | 0 | 0 | 1 | 1 | 1 | 0 | 0 | 1 |
| Page 2 | 1 | 1 | 1 | 1 | 0 | 0 | 0 | 0 | 0 | 0 | 0 | 0 | 1 | 1 | 1 | 1 |
| Page 1 | 1 | 1 | 1 | 1 | 1 | 1 | 1 | 1 | 0 | 0 | 0 | 0 | 0 | 0 | 0 | 0 |

Further, in another embodiment, the encoding scheme may make the bit value “1” more concentrated on the middle states and make the bit value “0” more concentrated on the two-side states. In such a situation, the bit data in a group may be reversed if the number of “0”s is greater than the number of “1”s in the group, and the bit data in a group may be remained if the number of “0”s is less than the number of “1”s in the group. Therefore, the state distribution maybe reshaped to decrease the occurrence probability of the two-side states by increasing the number of “1”s and decreasing the number of “0” stored in the memory cells.

To sum up, the present invention provides a data processing method for a memory such as a QLC NAND flash memory. Before the data is stored in the memory, the data is processed by a data processor. The data processor may divide a page of data into multiple groups, and determine the number of “1”s and the number of “0”s in each group, so as to determine whether to reverse or remain the bit data in the group. In an embodiment, the encoding scheme makes the bit value “0” more concentrated on the middle states of the state distribution than the bit value “1”. The data processor thereby reverses the bit data in a group if the number of “1”s is greater than the number of “0”s in the group, and remains the bit data in a group if the number of “1”s is less than the number of “0”s in the group. As a result, the occurrence probability of the states at two sides becomes lower and the occurrence probability of the middle states becomes higher, which reduces the probability that the state combination (E, D15) or (D15, E) appears in two adjacent cells. Therefore, the data retention problem of the memory may be mitigated.

Those skilled in the art will readily observe that numerous modifications and alterations of the device and method may be made while retaining the teachings of the invention. Accordingly, the above disclosure should be construed as limited only by the metes and bounds of the appended claims.

1. A data processing method, comprising:
dividing a page of bit data into a plurality of groups;
counting the number of a first bit value and the number of a second bit value in each of the plurality of groups;
comparing the number of the first bit value and the number of the second bit value;
performing a reshaping procedure on each of the plurality of groups based on the result of comparing the number of the first bit value and the number of the second bit value; and
storing the page of bit data in memory after the reshaping procedure;
wherein the reshaping procedure comprises at least one of:
reversing the bit data in a first group among the plurality of groups when the number of the first bit value is greater than the number of the second bit value in the first group; and
keeping the bit data in a second group among the plurality of groups when the number of the first bit value is less than the number of the second bit value in the second group; and
wherein bit values corresponding to a state distribution in a plurality of memory cells of the memory are encoded to allow the second bit value to be more concentrated on middle states of the state distribution than the first bit value.

2. (canceled)

3. The data processing method of claim 1, further comprising:
generating a flag indicating that the bit data in one of the plurality of groups are reversed or kept in the reshaping procedure.

4. The data processing method of claim 3, further comprising:
storing the flag in the memory.

5. (canceled)

6. The data processing method of claim 1, wherein the reshaping procedure modifies occurrence probability of at least one state in the state distribution in the memory cells.

7. The data processing method of claim 1, wherein the memory is a quad-level cell (QLC) NAND flash memory.

8. The data processing method of claim 7, wherein each cell of the QLC NAND flash memory is configured to store 4 bits of data belonging to 4 pages of bit data, respectively.

9. A data processor for processing bit data, the data processor comprising:
a receiver, for receiving a page of bit data; and
a processing unit, for performing the following units:
dividing unit, for dividing the page of bit data into a plurality of groups;
counting unit, for counting the number of a first bit value and the number of a second bit value in each of the plurality of groups;
comparing unit, for comparing the number of the first bit value and the number of the second bit value;
performing unit, for performing a reshaping procedure on each of the plurality of groups based on the result of the comparing unit; and
storing unit, for storing the page of bit data in memory after the reshaping procedure;
wherein the performing unit further comprises the following units:
reversing unit, for reversing the bit data in a first group among the plurality of groups when the number of the first bit value is greater than the number of the second bit value in the first group; and
keeping unit, for keeping the bit data in a second group among the plurality of groups when the number of the first bit value is less than the number of the second bit value in the second group; and
wherein bit values corresponding to a state distribution in a plurality of memory cells of the memory are encoded to allow the second bit value to be more concentrated on middle states of the state distribution than the first bit value.

10. (canceled)

11. The data processor of claim 9, wherein the processing unit further performs the following unit:
generating unit, for generating a flag indicating that the bit data in one of the plurality of groups are reversed or kept in the reshaping procedure.

12. The data processor of claim 11, wherein the storing unit further stores the flag in the memory.

13. (canceled)

14. The data processor of claim 9, wherein the reshaping procedure modifies occurrence probability of at least one state in the state distribution in the memory cells.

15. The data processor of claim 9, wherein the memory is a quad-level cell (QLC) NAND flash memory.

16. The data processor of claim 15, wherein each cell of the QLC NAND flash memory is configured to store 4 bits of data belonging to 4 pages of bit data, respectively.
